(19) United States
(12) Patent Application Publication
(10) Pub. No.: US 2005/0284345 A1
(43) Pub. Date: Dec. 29, 2005

(54) Safe with separately accessible inner areas

(75) Inventor: Martin Landwehr, Paderborn (DE)

Correspondence Address: MICHAUD-DUFFY GROUP LLP, 306 INDUSTRIAL PARK ROAD, SUITE 206, MIDDLETOWN, CT, 06457, US

(73) Assignee: NIXDORF INTERNATIONAL GMBH, PADERBORN (DE)

(21) Appl. No.: 10/526,423

(22) PCT Filed: Sep. 16, 2003
(86) PCT No.: PCT/DE03/03061

§ 371 Date: Mar. 1, 2005

(30) Foreign Application Priority Data
Oct. 1, 2002 (DE) 102 45 917.7

(51) Int. Cl. E06B 7/00

(52) U.S. Cl. 109/67

(57) ABSTRACT

A safe includes an inner safe door and an outer safe door, which at least partially overlap each other, it being possible for the safe doors to pivot about the same pivoting axis between a position covering the opening of the safe and a position releasing the opening. The inner safe door having a cutout through which at least one part of the space inside the safe is accessible after the outer safe door is opened, while the remaining inner area is accessible only after both safe doors are opened.

### CROSS-REFERENCE TO RELATED APPLICATIONS

This application is entitled to the benefit of and incorporates by reference essential subject matter disclosed in International Application No. PCT/DE2003/003061 filed on Sep. 16, 2003 and German Application No. 102 45 917.7 filed on Oct. 1, 2002.

### FIELD OF THE INVENTION

The invention relates to a safe with separately accessible interior areas.

### BACKGROUND OF THE INVENTION

Self-service automated teller machines are often set up for depositing and dispensing cash and for accepting checks. For filling and removing cash, strict security regulations apply: there must always be two authorized bank employees in attendance and in many cases armed security personnel must additionally be present. Expenditure on personnel is therefore high. On the other hand, accepted checks are invalidated by an imprint. After that, there is no longer any great security requirement for them.

In European Patent Application EP 1 227 448, a safe is disclosed with entry points for checks and cash in the upper part of the safe and with collection boxes in the lower part of the safe is proposed. In that safe the lower part with the collection boxes is closed by a solid inner safe door, which has no cutouts, and the upper part is closed by an additional outer safe door, which also covers the inner safe door.

The object of the invention is to propose a safe which has differently secured inner areas.

### SUMMARY OF THE INVENTION

According to aspects of the present invention, a safe is provided with an inner safe door and an outer safe door, which at least partially overlap each other. It is possible for the safe doors to pivot about the same pivoting axis between a position covering the opening of the safe and a position releasing said opening. In the preferred embodiment of the present invention, the inner safe door has a cutout through which at least one part of the space inside is accessible after the outer safe door is opened, while the remaining inner area is accessible only after both safe doors are opened.

An advantage of the present invention is that a standardized safe can be retrofitted. The space inside the safe can be provided with internal fittings as desired. All that is necessary is to design the inner safe door in a way corresponding to the internal fittings.

The overlapping arrangement of the safe doors makes it possible according to a preferred embodiment of the present invention to assign each safe door a dedicated locking mechanism which can be actuated by a lock.

Preferably, the safe door locking mechanisms can be actuated by a single lock, different unlocking privileges being assigned to different keys in such a way that a key with a low privilege is only able to unlock the outer safe door, while both safe doors can be unlocked at the same time with a key of high privilege.

### BRIEF DESCRIPTION OF THE DRAWINGS

An exemplary embodiment of the invention is explained below on the basis of the accompanying drawing, in which:

FIG. 1 shows an automated teller machine in a plan view taken in section along the line 1-1 in FIG. 3;

FIG. 2 shows a front view of the automated teller machine represented in FIG. 1, with the safe doors opened; and

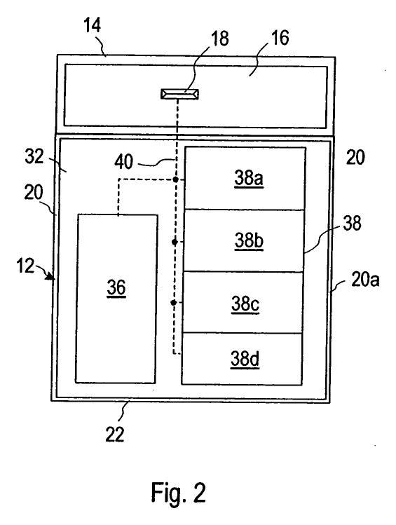

FIG. 3 shows a front view of the automated teller machine represented in FIG. 1 with the outer safe door opened and the inner safe door closed.

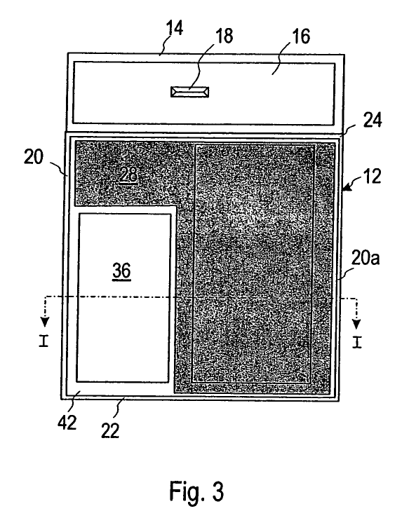

### DETAILED DESCRIPTION OF THE PREFERRED EMBODIMENTS

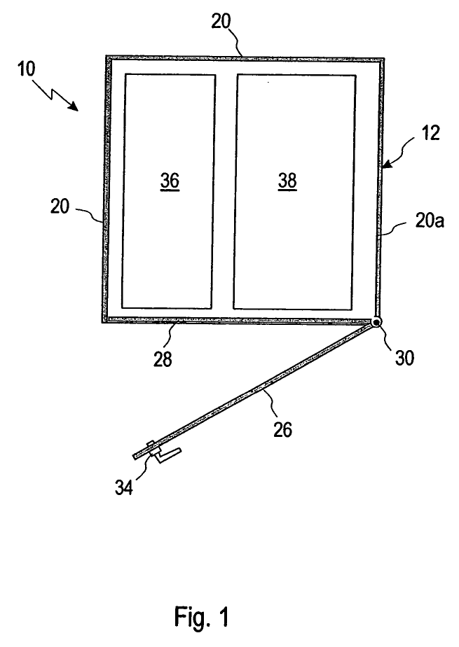

In FIG. 1, an automated teller machine 10 is represented in a sectioned plan view. The automated teller machine 10 comprises a safe 12 and a top attachment 14 with an operator control panel 16 (not represented in any more detail). Of the operating elements that are customary in the case of automated teller machines, only a depositing/dispensing compartment 18 for checks and banknotes is represented.

The side walls 20 of the safe 12 are armored, as are its base plate 22 and top plate 24. A likewise armored outer safe door 26 and an inner safe door 28 are articulated on one of the side walls 20a and can be pivoted individually about a pivoting axis 30 shared by both, between a position covering the opening 32 of the safe and a position releasing said opening. The outer safe door 26 is provided with a safe lock 34, which in its closed position connects the two safe doors 26, 28 to each other and locks them to the safe 12, in a first opening position unlocks only the outer safe door 26 and in a second opening position keeps the inner safe door 28 closed together with the outer safe door 26 but unlocked from the safe, so that the joined-together assembly of the two safe doors 26, 28 can be opened like a single safe door.

Fitted in the interior space of the safe 12 are a check container 36 and a banknote store 38. The latter contains four banknote boxes 38a-38d. A conveying path 40 connects the depositing/dispensing compartment 18 to the check container 36 and the banknote boxes 38a-38d. The inner safe door 28 has a cutout 42, which leaves the check container 36 clear, but covers over the banknote store 38 and the conveying path 40. When the inner safe door 28 is closed, access is therefore only possible to the check container 36, to which, as mentioned above, a low security level applies. While four banknote boxes have been shown and described, the present invention is not limited in this regard as any number of banknote boxes can be employed without departing from the broader aspects of the invention.

If a banknote box 38a-38d is to be exchanged, emptied or filled, or else the conveying path 40 is to be accessed, the safe lock 34 has to be actuated with a key of high privilege. By means of this key, the outer safe door 26 and the inner safe door 28 are locked together, but can be jointly unlocked from the safe. They can then be opened like a single safe door. In this case, the security measures described above are to be observed. On the other hand, the emptying of the check container 36 can be performed by a single person without infringing any security regulations. The saving on personnel expenditure is therefore considerable.

The invention makes it possible to arrange internal fittings of low and high security relevance at any desired locations of the space inside the safe. Internal fittings with low security relevance also do not have to be grouped together, but instead it is possible for the inner safe door 28 to be provided with a number of cutouts that are shaped and arranged as desired.

It is also possible to provide the safe 12 with more than two security levels: all that is then necessary is to adapt the number of inner safe doors to the number of security levels and to provide the safe lock 34 with a corresponding number of locking positions. The safe lock 34 may be able to be actuated with a mechanical key or be designed as a code lock which can be actuated electrically. It is also conceivable to provide the inner safe door, or a number of them, with separate locks.

While preferred embodiments of the present invention have been shown and described, the present invention is not limited in this regard as those skilled in the pertinent art to which the present invention pertains will understand that various modifications can be made without departing from the scope of the present invention.

1-6. (canceled)

7. A safe comprising: an inner safe door, an outer safe door, the inner and outer safe door at least partially overlapping each other, said inner and outer safe doors being pivotable about at least one of the same pivoting axis and different pivoting axis between a position covering an opening of the safe and a position releasing said opening, the inner safe door having at least one cutout through which at least a portion of a space defined inside the safe is accessible after the outer safe door is opened, and wherein the remaining inner area is accessible only after both safe doors are opened.

8. The safe as defined by claim 7, further comprising a safe lock and wherein the inner and outer safe doors each include a dedicated locking mechanism which can be actuated by said safe lock.

9. The safe as defined by claim 8, further comprising different keys each having different unlocking privileges assigned thereto and wherein the safe door locking mechanisms can be actuated by a single lock in such a way that a key with a low unlocking privilege is only able to unlock the outer safe door, while both safe doors can be unlocked at the same time with a key of high unlocking privilege.

10. The safe as defined by claim 8, wherein the lock is actuatable with a mechanical key.

11. The safe as defined by claim 8, wherein the lock is a code lock which can be actuated electrically.
